(19) United States
(12) Patent Application Publication
(10) Pub. No.: US 2025/0183499 A1
(43) Pub. Date: Jun. 5, 2025

(54) CURRENT COLLECTOR TERMINAL FOR BATTERY AND BATTERY

(71) Applicant: TOYOTA JIDOSHA KABUSHIKI KAISHA, Aichi-ken (JP)

(72) Inventor: Hideki HAGIWARA, Nagoya-shi (JP)

(21) Appl. No.: 18/957,866

(22) Filed: Nov. 25, 2024

(30) Foreign Application Priority Data
Dec. 1, 2023 (JP) 2023-203883

(51) Int. Cl. H01M 50/562; H01M 10/658; H01M 50/105; H01M 50/178; H01M 50/531; H01M 50/553

(52) U.S. Cl. CPC H01M 50/562; H01M 10/658; H01M 50/178; H01M 50/531; H01M 50/553; H01M 50/105

(57) ABSTRACT

The present disclosure provides a current collector terminal for a battery that can suppress heat transfer to an electrode laminate and a sealing portion of a laminate film at the time of joining with the external connection terminal while ensuring the electronic conductivity, and a battery comprising such a current collector terminal. The current collector terminal for a battery of the present disclosure comprises a current collector foil joint for joining a current collector foil of an electrode laminate, a peripheral portion for fusing a laminated film thereon, an external connection terminal joint for joining with an external connection terminal, and a low thermal conductivity region between the peripheral portion and the external connection terminal joint. The battery of the present disclosure comprises the electrode laminate, the current collector terminal of the present disclosure, and the laminated film.

### FIELD

The present disclosure relates to a current collector terminal for a battery and battery.

### BACKGROUND

Laminated batteries (also called pouch batteries) in which an electrode laminate is sealed with a laminated film are known.

For example, PTL 1 discloses a secondary battery that includes an electrode laminate obtained by laminating a sheet-like electrode element, and an outer body that houses the electrode laminate therein. The outer body includes a tubular laminated film outer body that covers at least both end surfaces of the electrode laminate in the lamination direction and a pair of opposing side surfaces, and an inner lid disposed in the opening of the laminated film outer body. The electrode laminate is sealed inside the outer body by joining an outer peripheral portion of the inner lid to the laminated film outer body that overlaps the outer peripheral portion of the inner lid.

Also, PTL 1 discloses that the outer peripheral portion of the inner lid and the laminated film outer body can be joined by thermal welding (fusion).

### CITATION LIST

### Patent Literature

[PTL 1]. Japanese Unexamined Patent Publication (Kokai) No. 2022-123686

### SUMMARY

### Technical Problem

In laminated batteries, there is also known batteries in which a current collector terminal itself is shaped like an inner lid described in PTL 1, that is, a current collector terminal has a predetermined volume, so that the current collector terminal seals an electrode laminate together with a laminated film. In the battery comprising such a current collector terminal, in order to form battery modules, when joining an external connection terminal to the current collector terminal, heat at the time of joining may transfer from the current collector terminal to the electrode laminate. As a result, the performance of the battery would be impaired.

Further, the above-described heat may transfer to a sealing portion of the laminated film in which the current collector terminal and the laminated film are fused to cause manufacturing defects such as a sealing defect.

On the other hand, in order not to impair the performance of the battery, it is necessary to ensure the electron conductivity at the current collector terminal.

An object of the present disclosure is to provide: a current collector terminal for a battery that can suppress heat transfer to an electrode laminate and a sealing portion of a laminate film at the time of joining with the external connection terminal while ensuring the electronic conductivity; and a battery comprising such a current collector terminal.

### Solution to Problem

The present inventors found that the above-mentioned problem could be solved by the following means.

### Aspect 1

A current collector terminal for a battery, comprising:
a current collector foil joint for joining a current collector foil of an electrode laminate;
a peripheral portion for fusing a laminated film thereon;
an external connection terminal joint for joining with an external connection terminal; and
a low thermal conductivity region between the peripheral portion and the external connection terminal joint.

### Aspect 2

The current collector terminal according to Aspect 1, wherein the low thermal conductivity region is formed by a through hole.

### Aspect 3

The current collector terminal according to Aspect 2, wherein the low thermal conductivity region is formed by filling the through hole with a material having a lower thermal conductivity than the other portion of the current collector terminal.

### Aspect 4

A battery, comprising:
the electrode laminate;
the current collector terminal according to any one of Aspects 1 to 3, which is electrically connected to the current collector foil of the electrode laminate; and
the laminated film sealing the electrode laminate together with the current collector terminal.

### Advantageous Effects of Invention

According to the present disclosure, it is possible to provide: a current collector terminal for a battery that can suppress heat transfer to an electrode laminate and a sealing portion of a laminate film at the time of joining with the external connection terminal while ensuring the electronic conductivity; and a battery comprising such a current collector terminal.

### BRIEF DESCRIPTION OF DRAWINGS

FIG. 1 is a schematic perspective view showing an example of the current collector terminal of the present disclosure.

FIG. 2 is a schematic plane view showing an example of the current collector terminal of the present disclosure.

FIG. 3 is a schematic plane view showing an example of the current collector terminal of the present disclosure.

FIG. 4 is a schematic plane view showing an example of the current collector terminal of the present disclosure.

FIG. 5 is a schematic plane view showing an example of the battery of the present disclosure.

### DESCRIPTION OF EMBODIMENTS

Embodiments of the present disclosure will now be described in detail. The present disclosure is, however, not limited to the below-described embodiments, and can be carried out with various modifications within the scope of the gist of the disclosure.

The current collector terminal for a battery and the battery of the present disclosure will be described below with reference to the drawings. The dimensional relationships in the drawings do not reflect the actual dimensional relationships.

### <Current Collector Terminal for Battery>

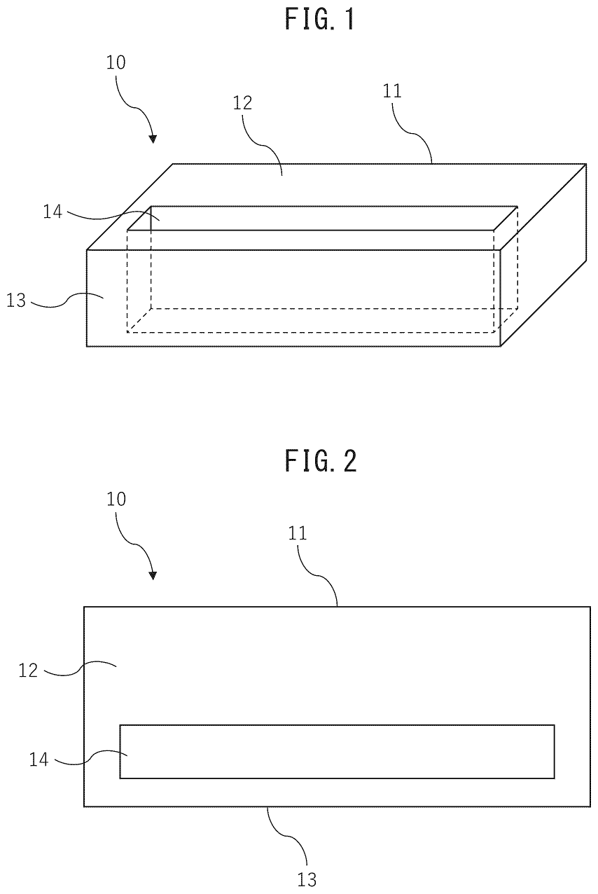

As shown in FIG. 1, the current collector terminal 10 for a battery of the present disclosure comprises a current collector foil joint 11 for joining a current collector foil of an electrode laminate 20, a peripheral portion 12 for fusing a laminated film thereon, an external connection terminal joint 13 for joining with an external connection terminal, and a low thermal conductivity region 14 between the peripheral portion 12 and the external connection terminal joint 13.

As described above, in order to form battery modules, when joining an external connection terminal to a current collector terminal, heat at the time of joining may transfer from the current collector terminal to an electrode laminate and a sealing portion of a laminated film in which the current collector terminal and the laminated film are fused.

In this regard, the present inventors have found that by providing a low thermal conductivity region in a current collector terminal, it is possible to reduce the thermal conductivity in the current collector terminal, and thus suppress heat transfer from the current collector terminal to an electrode laminate and a sealing portion of a laminated film, when an external connection terminal is joined to the current collector terminal.

As exemplified in FIG. 1, a shape of the current collector terminal 10 for a battery of the present disclosure may be a rectangular parallelepiped with, for example, a top surface portion, a bottom surface portion facing the top surface portion, and four side surface portions connecting the top surface portion and the bottom surface portion. In this case, the low thermal conductivity region 14, for example, may be a region formed so as to communicate the top surface portion and bottom surface portion. The current collector foil joint 11 may be a side surface portion of any one of the four side surface portions. The external connection terminal 13 may be a side surface portion facing the current collector foil joint 11 of the four side surface portions. The peripheral portion 12 may be formed from: a portion between the low thermal conductivity region 14 and the side surface portion that is the current collector foil joint 11, of the top surface portion and the bottom surface portion; and a side surface portion that is not the current collector foil joint 11 and the external connection terminal joint 13.

The shape of the current collector terminal is not limited to a rectangular parallelepiped. For example, a shape of the top surface portion of the current collector terminal includes quadrangular shapes, such as a square, a rectangle, a diamond, a trapezoid, a parallelogram, and the like. The shape of the top surface portion may be a polygonal shape other than a quadrangular shapes, or may be a shape having a curve, such as a circular shape. Further, a shape of the bottom portion may be the same as the shape of the top surface portion. A shape of the side surface portions is not particularly limited, and examples thereof include quadrangular shapes, such as a square, a rectangle, a rhomboid, a trapezoid, and a parallelogram.

The low thermal conductivity region 14 may be formed by a through hole. According to such a configuration, it is possible to particularly lower the thermal conductivity of the current collector terminal, and the effect of suppressing heat transfer from the current collector terminal to the electrode laminate and the sealing portion of the laminated film is easily achieved. Further, by reducing the weight of the current collector terminal, it is possible to contribute to reducing the weight of the battery.

The low thermal conductivity region 14 may be formed by filling the through hole with a material that has a lower thermal conductivity than the other portion of the current collector terminal. According to such a configuration, it is possible to reduce the thermal conductivity of the current collector terminal while maintaining the strength of the current collector terminal.

With regard to the present disclosure, a material of the current collector terminal is not particularly limited as long as it has a current collecting function, and may be, for example, the same metal material as that of the positive electrode current collector and the negative electrode current collector. Specifically, examples of the material of the current collector terminal include a metal material such as aluminum.

When the material other than the thermal conductivity region of the current collector terminal is a metal, the material constituting the low thermal conductivity region is not particularly limited, and examples thereof include resin and the like.

The volume of the low thermal conductivity region is not particularly limited, and can be appropriately designed depending on the volume of the current collector terminal, and the amount of heat when joining the external connection terminal to the current collector terminal, and the like.

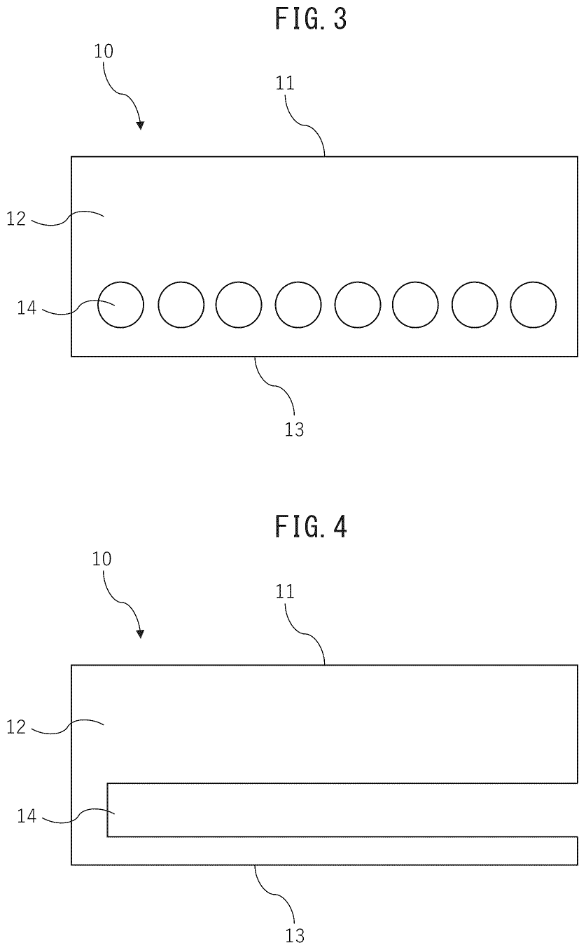

In FIGS. 1 and 2, although the low thermal conductivity region is shown as a rectangular parallelepiped, a shape of the low thermal conductivity region is not particularly limited. Examples of the planar shape of the low thermal conductivity region includes a quadrilateral shapes, such as a square, a rectangle, a rhomboid, a trapezoid, and a parallelogram. The planar shape of the low thermal conductivity region may be a polygonal shape other than a quadrangular shapes, or may be a shape having a curve, such as a circular shape (see FIG. 3).

The number of low thermal conductivity regions may not be particularly limited, and may be one or more (see FIG. 3).

As shown in FIG. 4, the low thermal conductivity region may be formed such that an end portion thereof comes into contact with a side surface portion of the current collector terminal. That is, a part of the side surface portion of the current collector terminal may be missing in order to form the low thermal conductivity region.

Methods for manufacturing the current collector terminal with the through hole as the low thermal conductivity region are not particularly limited, but include, for example, a method of punching with a press machine, a drill so as to make a desired shape, size, and the like.

Above, an embodiment has been described in which the low thermal conductivity region is formed by the through hole and is formed so as to extend in the lamination direction of the electrode laminate, but the direction in which the low thermal conductivity region extends is not particularly limited, and may be formed so as to extend in the plane direction of the electrode laminate, for example.

### «Battery»

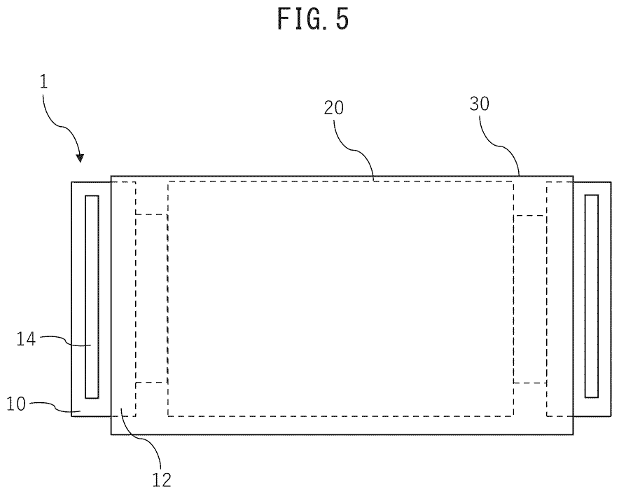

As exemplified in FIG. 5, the battery 1 of the present disclosure comprises the electrode laminate 20, the current collector terminal 10 of the present disclosure which is electrically connected to the current collector foil of the electrode laminate, and the laminated film 30 sealing the electrode laminate together with the current collector terminal.

The battery of the present disclosure may be a liquid battery or solid-state battery. Regarding the present disclosure, the term “solid-state battery” means a battery in which at least a solid electrolyte is used as an electrolyte; therefore, the solid-state battery may contain, as an electrolyte, a combination of a solid electrolyte and a liquid electrolyte. Further, the solid-state battery of the present disclosure may be an all-solid-state battery, i.e. a battery in which only a solid electrolyte is used as an electrolyte.

The battery of the present disclosure may be, for example, a lithium ion secondary battery as well. Examples of the use of this battery include power sources of vehicles, such as hybrid electric vehicles (HEVs), plug-in hybrid electric vehicles (PHEVs), battery electric vehicles (BEV), gasoline vehicles, and diesel vehicles. The battery is particularly preferably used as a power source for driving a hybrid electric vehicle (HEV), a plug-in hybrid vehicle (PHEV), or a battery electric vehicle (BEV). Further, the battery of the present disclosure may be used as a power source of a mobile body (e.g., a train, a ship, or an airplane) other than a vehicle, or as a power source of an electric appliance such as an information processing device.

### <Electrode Laminate>

The electrode laminate 20 functions as a power generation element of the battery 100. A shape of the electrode laminate is not particularly limited and, for example, the electrode laminate 10 may have a top surface section, a bottom surface section facing the top surface section, and four side surface sections connecting the top surface section and the bottom surface section. A shape of the top surface section is not particularly limited, and examples thereof include quadrangular shapes, such as a square, a rectangle, a rhomboid, a trapezoid, and a parallelogram. The shape of the top surface section may also be a polygonal shape other than a quadrangular shape, or may be a shape having a curve, such as a circular shape. Further, the bottom surface section has the same shape as the top surface section. A shape of the side surface sections is not particularly limited, and examples thereof include quadrangular shapes, such as a square, a rectangle, a rhomboid, a trapezoid, and a parallelogram.

The electrode laminate may include a positive electrode current collector layer, a positive electrode active material layer, an electrolyte layer, a negative electrode active material layer, and a negative electrode current collector layer in this order. Materials constituting each layer can be those commonly used in the field of batteries.

### <Laminated Film>

The laminated film 30 seals the electrode laminate 20 along with the current collector terminal 10. Specifically, the laminated film may be wound around the electrode laminate and the current collector terminal to seal the electrode laminate along with the current collector terminal. Further, the laminated film may be composed of first and second films and, in this case, the first and the second films sandwich the electrode laminate and the current collector terminal from above and below in the lamination direction of the electrode laminate to seal the electrode laminate along with the current collector terminal.

The laminated film may include a fusion bonding layer, a metal layer, and a protective resin layer in this order along the thickness direction. Examples of a material of the fusion bonding layer include olefin-based resins, such as polypropylene (PP) and polyethylene (PE). Examples of a material of the metal layer include aluminum, aluminum alloys, and stainless steel. Examples of a material of the protective resin layer include polyethylene terephthalate (PET) and nylon. The fusion bonding layer has a thickness of, for example, 40 μm to 100 μm. The metal layer has a thickness of, for example, 30 μm to 60 μm. The protective resin layer has a thickness of, for example, 20 μm to 60 μm. The laminated film has a thickness of, for example, 80 μm to 250 μm.

### <Current Collector Terminal>

For the current collector terminal, reference can be made to the above description of the current collector terminal for a battery of the present disclosure.

### REFERENCE SIGNS LIST

1 battery
10 current collector terminal for battery
11 current collector foil joint
12 peripheral portion
13 external connection terminal joint
14 low thermal conductivity region
20 electrode laminae
30 laminated film

1. A current collector terminal for a battery, comprising:
a current collector foil joint for joining a current collector foil of an electrode laminate;
a peripheral portion for fusing a laminated film thereon;
an external connection terminal joint for joining with an external connection terminal; and
a low thermal conductivity region between the peripheral portion and the external connection terminal joint.

2. The current collector terminal according to claim 1, wherein the low thermal conductivity region is formed by a through hole.

3. The current collector terminal according to claim 2, wherein the low thermal conductivity region is formed by filling the through hole with a material having a lower thermal conductivity than the other portion of the current collector terminal.

4. A battery, comprising:
the electrode laminate;
the current collector terminal according to claim 1, which is electrically connected to the current collector foil of the electrode laminate; and
the laminated film sealing the electrode laminate together with the current collector terminal.
